(19) United States
(12) Patent Application Publication
(10) Pub. No.: US 2006/0285446 A1
(43) Pub. Date: Dec. 21, 2006

(54) Time display apparatus

(76) Inventors: Hwa Su, Ping Cheng City (TW); Alexander Chan Wang, Ping Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/263,907

(22) Filed: Nov. 2, 2005

(30) Foreign Application Priority Data
May 17, 2005 (TW) 094207985

(51) Int. Cl. G04B 19/00; G04B 25/00; G04C 17/00

(52) U.S. Cl. 368/223

(57) ABSTRACT

A time display apparatus for displaying time with phosphorescent materials illuminated by light with a fixed wavelength. The invention employs transparent pointers deposited with at least one phosphorescent material and illuminated by light with a fixed wavelength in order to show time with various colors. Moreover, there are provided many combinations of these transparent pointers for displaying time with multicolored manners.

### FIELD OF THE INVENTION

The present invention relates to a time display apparatus, and more particularly, a time display apparatus showing time by utilizing a light beam with a fixed wavelength on a phosphorescent material.

### BACKGROUND OF THE INVENTION

As time passed, the exhibition of displaying time becomes a great of diversities. People try to know the present time through various ways. At the beginning, there were primitive sundials, sandglasses, then mechanical clocks, and now digital clocks or watches. In FIG. 1, it is a perspective diagram showing the structure of the main body portion of a clock in the prior art. Herein, the main body portion of the clock comprises a clock housing 11, a timetable panel 12 and at least one pointer 13 wherein the clock housing 11 contains the timetable panel 12 and further contains the pointer 13 positioned above the timetable panel 12. Within the clock housing 11, the pointers 13 may comprises at least one hour pointer 14, one minute pointer 15 and one second pointer 16 wherein the length of the hour pointer 14 is shorter than that of the minute pointer 15 or that of the second pointer 16, and the width of the second pointer 16 is thinner than that of the hour pointer 14 or that of the minute pointer 15. There are many ways to display time with various combinations of the pointers 13.

In the early stage, the pointers can not be seen in the dark. However, with modifications made by people, the combinations of the pointers can be seen in the dark as the example represented in FIG. 2 which includes a perspective diagram and a dissection diagram showing the structure of the main body portion of a clock able to show time information in the dark in the prior art. The clock housing 11 in FIG. 1 holds a timetable panel 12 and a pointer 13 positioned above the timetable panel 12. In the cooperation with the time display apparatus structure in FIG. 1, adding fluorescent materials 21 into the pointer 13 to form a pointer 22 containing fluorescent materials 21. Furthermore, the pointer 22 contains an hour pointer 23, a minute pointer 24 and a second pointer 25 wherein the length of the hour pointer 23 is shorter than that of the minute pointer 24 or that of the second pointer 25, and the width of the second pointer 25 is thinner than that of the hour pointer 23 and that of the minute pointer 24. With the fluorescent pointers 22, the time information can be seen in the dark. However, the time period of light emitting is only temporary and limited by the characteristics of fluorescent materials. After a while, the light emitted from the pointers vanishes and becomes one of the disadvantages of the clocks utilizing the fluorescent materials. There is only one color shown by using the fluorescent material on the pointers.

It is an objective of the present invention utilizing one back light unit and pointers deposited with diverse phosphorescent materials for displaying time with various fashion styles. Furthermore, the lasting time of the phosphorescent materials is longer than that of fluorescent materials enabling us to see the time display with extensive duration. With the diverse phosphorescent materials, many colorful appearances are possible.

### SUMMARY OF THE INVENTION

The present invention discloses a time display apparatus for displaying time with phosphorescent materials illuminated by light with a fixed wavelength. The invention employs transparent pointers deposited with at least one phosphorescent material and illuminated by light with a fixed wavelength in order to show time with various colors. Moreover, there are provided many combinations of these transparent pointers for displaying time with multicolored manners.

The present invention provides a time display apparatus comprising a clock housing in which there is at least one transparent pointer deposited with at least one phosphorescent material. Numerous colors are performed from the transparent pointers illuminated by at least one back light unit.

The features and advantages of the present invention are further described as preferred embodiments and illustrated in the descriptions and accompanying drawings.

### BRIEF DESCRIPTION OF THE DRAWINGS

FIG. 1 is a perspective diagram showing the structure of the main body portion of a clock in the prior art;

FIG. 2 includes a perspective diagram and a dissection diagram showing the structure of the main body portion of a clock able to show time information in the dark in the prior art;

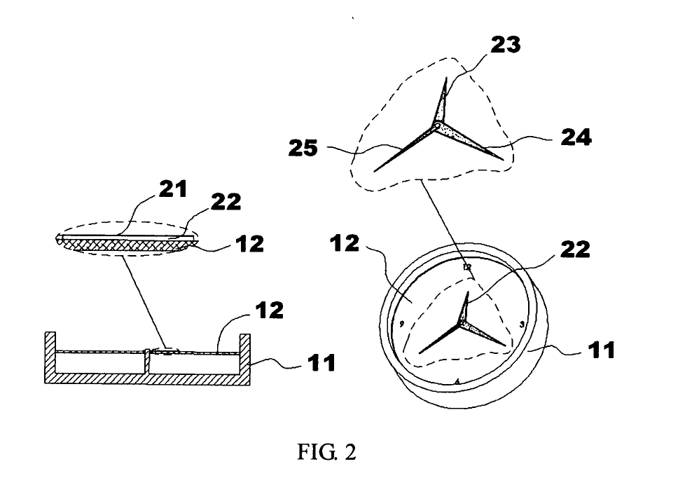

FIG. 3 includes a perspective diagram and a dissection diagram showing a back light unit and at least one phosphorescent material of the time display apparatus;

FIG. 4 includes a perspective diagram and a dissection diagram showing another back light unit and at least one phosphorescent material of the time display apparatus;

FIG. 5 includes a perspective diagram and a dissection diagram showing still another back light unit and at least one phosphorescent material of the time display apparatus;

FIG. 6 is a flow chart for performing diversities of coloring by using different combinations of pointers according to a preferred embodiment of the invention; and

FIG. 7 is a diagram of an embodiment of the present invention with back light units in various appearances and arrangements.

### DETAILED DESCRIPTION OF THE PREFERRED EMBODIMENTS

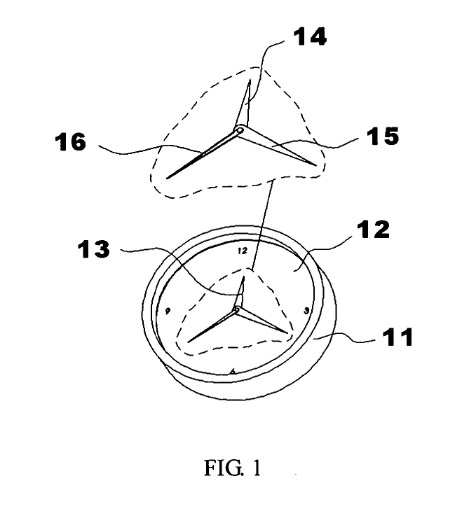

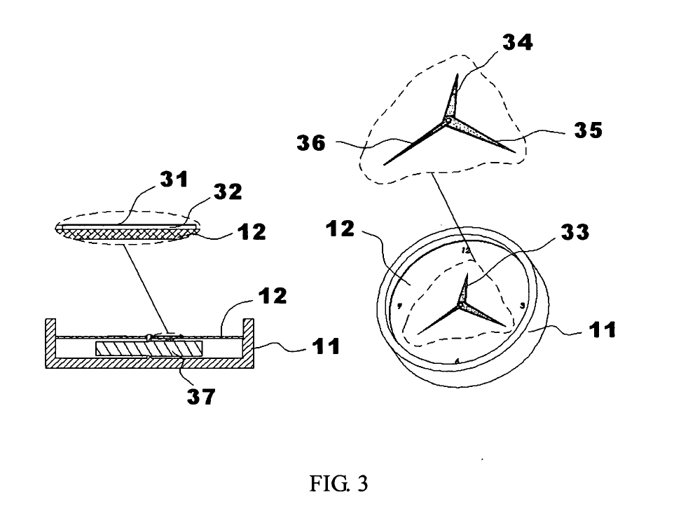

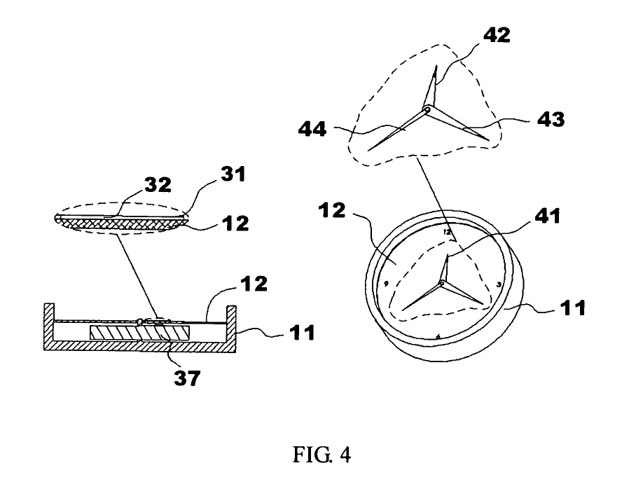

In FIG. 3, it is a perspective diagram and a dissection diagram showing the back light unit and at least one phosphorescent material of the time display apparatus. Herein, a time display apparatus as mentioned in FIG. 1 comprises a clock housing 11, a timetable panel 12 contained inside the clock housing 11, sharp pointers 33 comprising a transparent sharp pointer 32 deposited a phosphorescent material 31. The sharp pointer 33 with the phosphorescent material 31, covering the transparent sharp pointer 32, further comprises an hour pointer 34, a minute pointer 35 and a second pointer 36. Moreover, different phosphorescent materials 31 can be added into the sharp pointer 33, containing a phosphorescent material 31, for creating various colors. Furthermore, a back light unit 37, positioned beneath the timetable panel 12, emitting a light with a fixed wavelength can generate more colors from the original colors of the phosphorescent materials 31 of the sharp pointers 33. In FIG. 4, it includes a perspective diagram and a dissection diagram showing another back light unit and at least one phosphorescent material of the time display apparatus. Herein, the time display apparatus comprises a clock housing 11, a timetable panel 12 encompassed by the clock housing 11, and sharp pointers 41 comprising a transparent sharp pointer 32 deposited a phosphorescent material 31. The sharp pointer 41 with the phosphorescent material 31, covering the transparent sharp pointer 32, further comprises an hour pointer 42, a minute pointer 43 and a second pointer 44. Moreover, different phosphorescent materials 31 can be added into the sharp pointer 41, containing a phosphorescent material 31, for creating various colors. Furthermore, a back light unit 37, positioned beneath the timetable panel 12, emitting a light with a fixed wavelength can generate more colors from the original colors of the pointers 41 with the phosphorescent material 31.

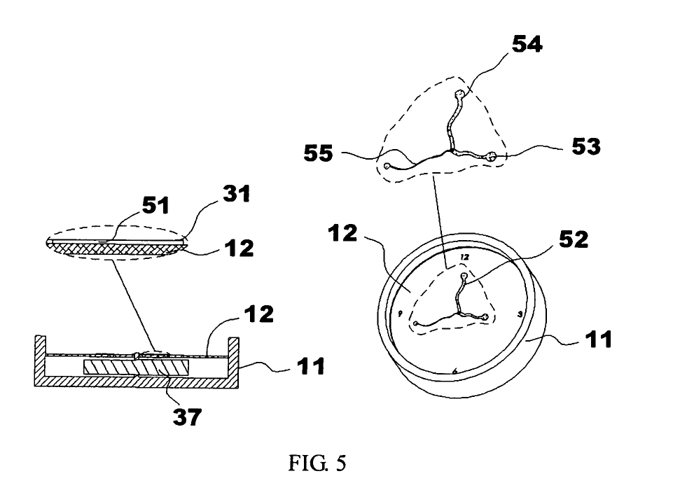

FIG. 5 includes a perspective diagram and a dissection diagram showing still another back light unit and at least one phosphorescent material of the time display apparatus. Herein, the time display apparatus comprises a clock housing 11, a timetable panel 12 encompassed by the clock housing 11, and sharp pointers 52 comprising a transparent styling pointer 52 deposited with a phosphorescent material 31. The styling pointer 52 with the phosphorescent material 31, covering the transparent pointer 51, further comprises an hour pointer 53, a minute pointer 54 and a second pointer 55. Moreover, different phosphorescent materials 31 can be added into the styling pointer 52, containing a phosphorescent material 31, for creating various colors. Furthermore, a back light unit 37, positioned beneath the timetable panel 12, emitting a light with a fixed wavelength can generate more colors from the original colors of the styling pointers 52 deposited with the phosphorescent material 31.

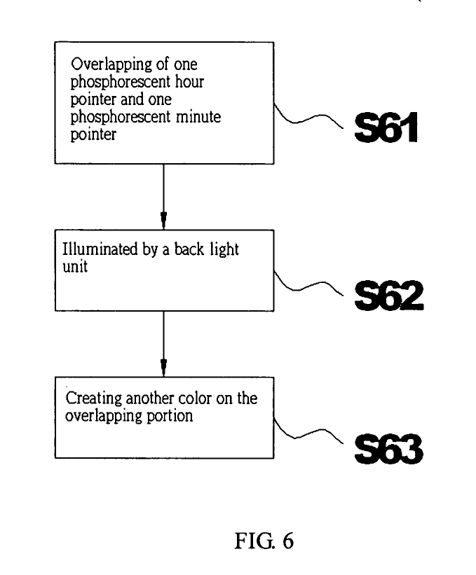

FIG. 6 is a flow chart for creating various coloring by using different combinations of pointers according to a preferred embodiment of the invention. Performing the colorful combinations of the pointers in the preferred embodiment includes the following steps: step S61, overlapping the hour pointer 34 deposited with a phosphorescent material 31 and the minute pointer 35 deposited with a phosphorescent material 31; step S62, illuminated by a back light unit 37; and S63, creating another new color from the overlapping portion of the pointers.

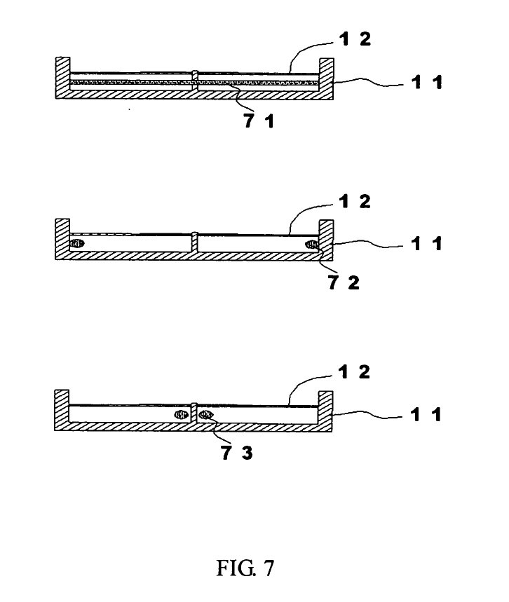

It is possible to have numerous variations by modifying the arrangement and appearance of the back light unit of the present invention. As illustrated in FIG. 7, it is a diagram of another embodiment of the present invention with back light units in various appearances and arrangements. There are at least three different applications by altering the appearance and arrangement of the back light unit 37 wherein the first application on the top portion of FIG. 7 includes a back light unit 37 which is a disk-like back light unit distributed uniformly beneath the timetable panel 12 that forms a back light unit 71 with flat piece; the second application in the middle position employs a back light unit 37 which is a ring-shaped back light unit traveling circularly around the boarder of the clock housing 11 that forms a back light unit 72 with circular shape; and third application in the bottom position utilizes a back light unit 37 which is also a ring-shaped back light unit but traveling circularly near the central point that forms a back light unit 73 with central circular shape.

Through the descriptions of the above embodiments of the present invention for providing a time display apparatus including a back light unit and a pointer with phosphorescent materials, the vanishment problem of the clocks with fluorescent materials for indicating the time can be solved, and more available styles and appearances are possible for users. Although the features and advantages of the embodiments according to the preferred invention are disclosed, it is not limited to the embodiments described above, but encompasses any and all modifications and changes within the spirit and scope of the following claims.

What is claimed is:

1. A time display apparatus, comprising:
a clock housing;
a timetable panel, held by the clock housing;
at least one pointer, positioned above the timetable panel;
an illuminant material, placed on the pointer; and
a back light unit, held by the clock housing and beneath the pointer.

2. The time display apparatus according to claim 1, wherein the clock housing is a housing of a wrist watch.

3. The time display apparatus according to claim 1, wherein the clock housing is a housing of a clock.

4. The time display apparatus according to claim 1, wherein the pointer is an hour pointer.

5. The time display apparatus according to claim 1, wherein the pointer is a minute pointer.

6. The time display apparatus according to claim 1, wherein the pointer is a second pointer.

7. The time display apparatus according to claim 4, wherein the hour pointer is shorter than the minute pointer and the second pointer.

8. The time display apparatus according to claim 1, wherein the pointer comprises a transparent material.

9. The time display apparatus according to claim 8, wherein the transparent material is a product of plastics.

10. The time display apparatus according to claim 8, wherein the transparent material is a product of glass.

11. The time display apparatus according to claim 1, wherein the illuminant material is a phosphorescent material.

12. The time display apparatus according to claim 1, wherein the back light unit is a light source with a fixed wavelength.
